(19) United States
(12) Patent Application Publication
(10) Pub. No.: US 2026/0063540 A1
(43) Pub. Date: Mar. 5, 2026

(54) SPECTROPHOTOMETER, METHOD OF SPECTROPHOTOMETRIC MEASUREMENT, AND PROGRAM

(71) Applicant: HITACHI HIGH-TECH ANALYSIS CORPORATION, Tokyo (JP)

(72) Inventors: Yuka IWAYA, Tokyo (JP); Youichi SATOU, Tokyo (JP); Yoshiaki KUSHIDA, Tokyo (JP); Kanta SAKURABA, Tokyo (JP)

(21) Appl. No.: 19/311,727

(22) Filed: Aug. 27, 2025

(30) Foreign Application Priority Data
Aug. 28, 2024 (JP) 2024-146488

(51) Int. Cl. G01N 21/31

(52) U.S. Cl. CPC G01N 21/31

(57) ABSTRACT

A spectrophotometer includes a light source, a spectrometer separating light from the light source, a beam splitter separating a light path of the light separated by the spectrometer into sample-side luminous flux and reference-side luminous flux, a sample-side detector detecting the sample-side luminous flux that has passed through a measurement sample and a reference-side detector detecting the reference-side luminous flux that has passed through a reference-side sample, a controller obtaining spectral intensity distribution of the sample-side luminous flux from the measurement sample and spectral intensity distribution of reference-side luminous flux from the reference sample, wherein the controller repeatedly performs measurement of a baseline a plurality of times at a wavelength changing speed at the time of actual measurement for measuring the measurement sample, thereby performing an averaging process of averaging accumulated values of a plurality of measurement values of the baseline.

### CROSS REFERENCE TO RELATED APPLICATION

The present application claims priority to Japanese Patent Applications No. JP2024-146488, filed Aug. 28, 2024, the entire contents of which are incorporated herein for all purposes by this reference.

### BACKGROUND

### Technical Field

The present disclosure relates to a spectrophotometer, a method of spectrophotometric measurement, and a program.

### Description of the Related Art

When performing spectral analysis of a sample using a spectrophotometer, the obtained measurement data (spectral intensity distribution) includes background intensity superimposed due to various factors, including the installation environment of the spectrophotometer, electrical noise, and absorption by the target substance. In order to eliminate the influence of such background intensity, in the related art, a method of subtracting a baseline obtained by measurement without a sample from sample measurement data obtained by performing measurement with a sample present has been commonly used. Further, the light emitted from a light source in a spectrophotometer has different energy values depending on the wavelength ranges, and particularly when an energy value is low, even slight variations in the energy value can have a significant impact on the measurement results (transmittance, absorbance, reflectance, etc.). Therefore, for high-accuracy measurements, it is required to accurately determine the baseline described above.

As a technique for determining such a baseline, for example, Patent Document 1 describes a method of setting the baseline in a gas chromatograph that detects a sample gas conveyed by a carrier gas and analyzes its components. In this analysis method of a gas chromatograph, only the carrier gas is passed through a column while recording a fluctuation value of baseline voltage, and the components of the sample gas are measured based on the recorded fluctuation value of the baseline voltage. In this case, the baseline is set using the average value of the baseline voltage that fluctuates due to gain switching within the measurement cycle, etc.

### PRIOR ART DOCUMENT

### Patent Document

Japanese Patent Application Publication No. 1993-113436

### SUMMARY

However, since the light sources that are used in spectrophotometers have differences in energy values depending on the wavelength ranges, a baseline should be averaged in accordance with the wavelength range of an energy value, as described above. For this reason, it is difficult to simply apply the technique of performing correction through averaging described in Patent Document 1 to baseline correction in a spectrophotometer.

Further, as a measure against time-dependent variation (noise) in the light quantity from a light source (noise), there is an approach to increase the integration value in baseline measurement by reducing a scan speed (wavelength change speed) that changes the wavelength of the light that is extracted from a spectrometer. However, unless measurement conditions between baseline measurement and actual sample measurement are as similar as possible, it is difficult to obtain a more accurate baseline correction value, and, due to the overlap of noise, the accuracy of baseline correction cannot be maintained. For this reason, there arises the need to set a scan speed to the same slow wavelength change speed as in baseline measurement, in actual measurement as well, so there is the problem that the measurement time is increased in the actual measurement.

Accordingly, an objective of the present disclosure is to provide a spectrophotometer, a method of spectrophotometric measurement, and a program capable of obtaining highly accurate analysis result by appropriately averaging a baseline even without slowing a wavelength change speed in actual measurement of a sample.

The present disclosure has the following configurations.

(1) A spectrophotometer including:
a light source;
a spectrometer configured to separate light from the light source at a specified wavelength changing speed;
a detector configured to detect sample transmission luminous flux that is transmitted through a measurement sample, which has been separated by the spectrometer and transmitted through the measurement sample, for each wavelength; and
a controller configured to obtain spectral intensity distribution of the luminous flux that is transmitted through the measurement sample based on a measurement sample signal of the luminous flux that is transmitted through the measurement sample outputted from the detector,
wherein the controller repeatedly performs measurement of a baseline, which represents background intensity of the measurement sample signal for each wavelength, a plurality of times at a wavelength changing speed at the time of measurement of the measurement sample and obtains an averaged baseline by averaging a plurality of measurement values of the baseline for each wavelength; and
corrects the spectral intensity distribution using the averaged baseline.

(2) A method of spectrophotometric measurement that separates light from a light source at a specified wavelength changing speed, detects sample transmission luminous flux that is transmitted through a measurement sample, which is transmitted through the measurement sample, for each wavelength, and obtains spectral intensity distribution of the luminous flux that is transmitted through the measurement sample based on a measurement sample signal of the luminous flux that is transmitted through a measurement sample that is detected, wherein the method
repeats measurement of a baseline, which represents background intensity of the measurement sample signal for each wavelength, a plurality of times at a wavelength changing speed that is identical to the wavelength changing speed at the time of measurement of the spectral intensity distribution;
obtains an averaged baseline by averaging a plurality of measurement values of the baseline that is repeatedly measured for each wavelength, and
corrects the spectral intensity distribution using the averaged baseline.

(3) A program for performing a procedure of spectrophotometric measurement that separates light from a light source at a specified wavelength changing speed, detects sample transmission luminous flux that is transmitted through a measurement sample, which is transmitted through the measurement sample, for each wavelength, and obtains spectral intensity distribution of the luminous flux that is transmitted through the measurement sample based on a measurement sample signal of the luminous flux that is transmitted through the measurement sample that is detected,
wherein the program executes: in a computer,
a procedure of repeating measurement of a baseline, which represents background intensity of the measurement sample signal for each wavelength, a plurality of times at a wavelength changing speed that is identical to the wavelength changing speed at the time of measurement of the spectral intensity distribution;
a procedure of obtaining an averaged baseline by averaging a plurality of measurement values of the baseline that is repeatedly measured for each wavelength, and
a procedure of correcting the spectral intensity distribution using the averaged baseline.

According to the present disclosure, when measuring a sample using a spectrophotometer, it is possible to obtain an analysis result with high accuracy by appropriately averaging a baseline even without decreasing a wavelength changing speed in actual measurement of a sample.

### BRIEF DESCRIPTION OF THE DRAWINGS

FIG. 1 is a schematic configuration diagram of a spectrophotometer according to a first embodiment;

FIG. 2 is a flowchart illustrating measurement by spectrophotometer;

FIG. 3 is a flowchart illustrating an averaging process of a baseline;

FIG. 4 is a schematic diagram showing a part of an input image on a display unit;

FIG. 5 is a flowchart illustrating an averaging process of a baseline in a second embodiment; and

FIG. 6 is a graph showing an example of an energy value in the type information of a light source.

### DETAILED DESCRIPTION

Hereafter, embodiments of the present disclosure are described in detail with reference to the drawings.

### First Embodiment

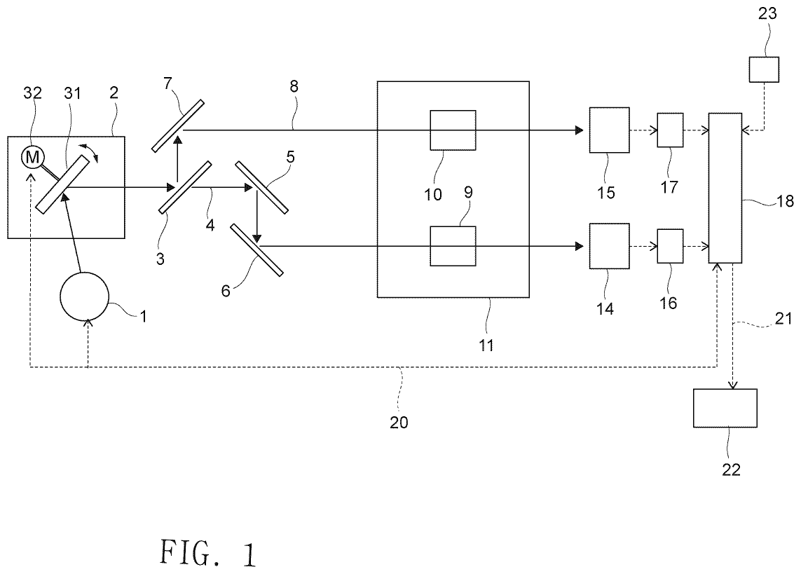

FIG. 1 is a schematic configuration diagram of a spectrophotometer 100 according to a first embodiment. FIG. 1 shows optical paths with solid arrows and the flow of signal processing with dashed arrows. The spectrophotometer 100 according to this embodiment includes a light source 1, a spectrometer 2, a beam splitter 3, mirrors 5, 6, and 7, a sample chamber 11, a sample stage 9, a reference sample stage 10, a sample-side detector 14, a reference-side detector 15, a sample-side converter 16, a reference-side converter 17, a controller 18, a display unit 22, and an instruction input portion 23.

The light source 1 is, for example, a white light source, and the emitted light is dispersed in the spectrometer 2 as shown by the solid arrows in FIG. 1, where specific wavelengths are extracted, and the light is separated into sample-side luminous flux 4 and reference-side luminous flux 8 at the beam splitter 3.

The spectrometer 2, for example, includes a diffraction grating 31 and a motor 32 for rotating and scanning the diffraction grating 31. The spectrometer 2 changes the wavelength of the light extracted from the light source 1 by rotating the diffraction grating 31 by driving the motor 32. The rotation speed of the diffraction grating 31 becomes the wavelength change speed of the light being extracted. Alternatively, the light source 1 may be a wavelength-variable laser device that can freely change the wavelength of laser light, instead of using the spectrometer 2, and it may be a configuration that extracts desired wavelength light.

The sample stage 9 on which a sample that is a measurement target is placed, and the reference sample stage 10 on which a reference sample is placed are disposed in the sample chamber 11. Further, the sample chamber 11 has windows (not shown) so that beams of light reflected by the mirrors 6 and 7 travel to the sample-side detector 14 and the reference-side detector 15 after passing through the sample stage 9 and the reference sample stage 10, respectively.

The sample-side luminous flux 4 having passed through the beam splitter 3 is reflected by the mirrors 5 and 6 and the reference-side luminous flux 8 reflected by the beam splitter 3 is reflected by the mirror 7, and then they are induced to the sample chamber 11. The sample-side luminous flux 4 passes through the measurement sample placed on the sample stage 9 in the sample chamber 11, and transmitted light of the measurement sample is detected by the sample-side detector 14. Meanwhile, the reference-side luminous flux 8 passes through the reference sample placed on the reference sample stage 10 in the sample chamber 11 and is then detected by the reference-side detector 15.

The sample-side converter 16 and the reference-side converter 17 are each equipped with an amplifier for signal amplification and an A/D converter, and process and output signals from the sample-side detector 14 and the reference-side detector 15, to the controller 18. That is, the transmitted light quantity of the sample luminous flux 4 detected by the sample-side detector 14 and the transmitted light quantity of the reference luminous flux 8 detected by the reference-side detector 15 are output as electrical signals, and then respectively amplified in the sample-side converter 16 and reference-side converter 17, converted from analog signals to digital signals, and transmitted to the controller 18.

The controller 18 generally controls the entire spectrophotometer 100. For example, the controller 18 instructs the measurement operation of the sample placed in the sample chamber 11 and performs analysis based on the obtained measurement result. The controller 18 is configured as a computer device including a processor such as a Central Processing Unit (CPU) and a Graphics Processing Unit (GPU), a storage such as a Hard Disk Drive (HDD) and a Solid State Drive (SSD), and a memory such as Read Only Memory (ROM) and Random Access Memory (RAM). The controller 18 implements various functions by reading out and executing various programs stored in the storage.

Further, the controller 18 receives setting parameters and various types of information through the instruction input portion 23 and operates the spectrophotometer 100 based on the received information. Further, it was described in this embodiment that the controller 18 for controlling components of the spectrophotometer 100 generally controls the components, but the spectrophotometer 100 may also be configured to operate by having separate controllers, which work in coordinate, for respective components. Further, the controller 18 and the measurement unit, which includes an optical system, may be independently configured as separate devices, and they may work together to perform subsequent operations.

The display unit 22 includes a display device such as a liquid crystal display panel. Measurement results or the information of each part is displayed on the display device based on a display signal 21 processed by the controller 18. A user of the spectrophotometer 100 can comprehend information such as measurement results and the status of the device from the content displayed on the display unit 22.

The instruction input portion 23 includes a User Interface (UI) for receiving various instructions or settings from the user of the spectrophotometer 100 and a touch panel display, etc. integrated with the display unit 22 may also be used. Further, the instruction input portion 23 may include an input device such as a keyboard or a mouse.

In the spectrophotometer 100 of the above configuration, light of an arbitrary wavelength is extracted from the light emitted by the light source 1 and emitted to a measurement sample by the spectrometer 2, and a predetermined calculation is performed using the transmitted light quantity detected by the sample-side detector 14 and the light quantity detected by the reference-side detector 15, whereby spectral intensity distribution is obtained. Absorption, transmission, and reflection light quantities of the measurement sample can be obtained from the spectral intensity distribution. For example, in the case of absorption measurement of a solution, the absorbance obtained from a solution sample containing a component with a known concentration is compared with the absorbance of a sample with an unknown concentration, whereby a user can obtain the concentration of the unknown sample.

That is, the controller 18 obtains the spectral intensity distribution of a measurement sample based on a digital signal outputted from the sample-side converter 16 and the reference-side converter 17, and calculates the absorbance, transmittance, reflectance, sample-side energy value, reference-side energy value, etc., of the measurement sample in accordance with specified instructions. Instruction information such as conditions for operating the spectrophotometer 100 is input to the spectrophotometer 100 in accordance with operation of the instruction input portion 23 by a user. The controller 18 transmits a device control signal 20 and controls components such as the light source 1 and the spectrometer 2 in accordance with input of instruction information from the instruction input portion 23.

The spectrophotometer 100 shown in FIG. 1 is a double beam spectrophotometer that performs measurement by emitting sample-side luminous flux 4 and reference-side luminous flux 8 to a measurement sample and a reference sample. The double beam spectrophotometer 100 includes a reference sample stage and measures a measurement sample based on measurement data of a reference sample. In measurements using the double beam method, it is possible to avoid the influence of unevenness in the energy value of the light source 1 over measurement time, so stable long-term measurements are possible.

Further, the spectrophotometer 100 performs baseline measurement separately from the measurement of a sample. A baseline is a profile that represents the background intensity of a measurement sample signal for each wavelength and is data for correcting the spectral intensity distribution of a measured sample. In detail, without setting a sample on the sample stage and the reference sample stage 10, the value of a transmitted light quantity obtained by performing a spectroscopic measurement is acquired as baseline information. In this baseline measurement, it is acceptable to set a blank sample, such as pure water, on the sample stage 9 and the reference sample stage 10 and perform measurement.

In the double beam spectrophotometer 100, a measurement value after correction is calculated, for example, based on Equation (1).

$$measurement value = ( Is / Ir ) / ( Bs / Br ) \qquad ( 1 )$$

where
Is: measurement value of sample-side light flux
Ir: measurement value of reference-side luminous flux
Bs: baseline value of sample-side luminous flux
Br: baseline value of reference-side luminous flux

Next, an example of the spectroscopic measurement procedure by the spectrophotometer 100 described above is described.

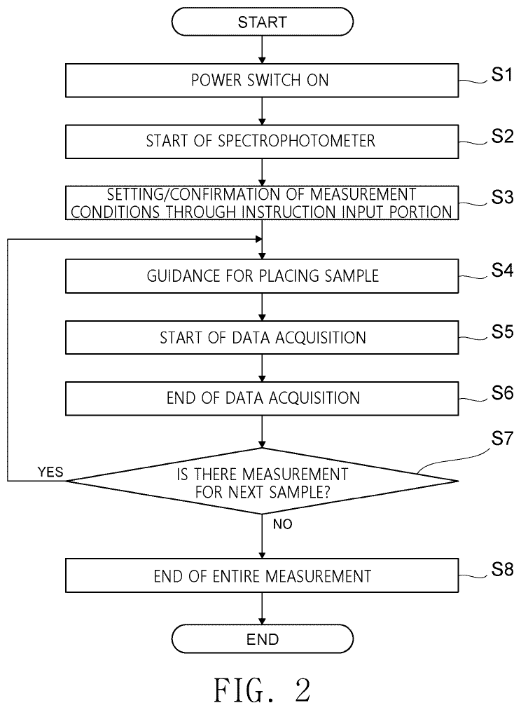

FIG. 2 is a flowchart showing basic measurement control processing that is performed by the controller 18. The procedure shown here assumes that baseline measurement is separately performed, and omits the description of the baseline measurement.

First, when a power switch of the spectrophotometer 100 (not shown) is turned on (step 1, hereinafter also referred to as “S1”), the spectrophotometer 100 starts up (S2). Then, the light source 1, the spectrometer 2, beam splitter 3, sample-side detector 14, reference-side detector 15, sample-side converter 16, reference-side converter 17, controller 18, and display unit 22 are all in operation, and the device control process begins.

A user sets measurement conditions, such as the wavelength range of light that is emitted to a measurement sample, for operating the spectrophotometer 100 by operating the instruction input unit 23 in accordance with the measurement sample. Thus, the components such as the light source 1, the spectrometer 2, and the beam splitter 3 are set to desired conditions (S3).

Further, guidance for the user to place a sample on the sample stage 9 of the sample chamber 11 is displayed on the display unit 22 (S4).

After the user performs operation in accordance with the guidance, data acquisition is started (S5). After acquiring specified data (S6), when there is next measurement in the measurement conditions set in step S3, the procedure returns to step S4 (S7). When there is no next measurement, measurement is ended (S8). The measurement result is displayed on the display unit 22, as described above.

As the light source 1 of the spectrophotometer 100, deuterium discharge lamps, tungsten iodide lamps, or xenon flash lamps are generally used. In particular, since xenon flash lamps have low heat emission, and moreover, they can be pulsed (intermittent ignition), they can be turned on and off precisely depending on situations.

However, the light from these light sources has different energy values depending on wavelength ranges, and fluctuations in these energy values can adversely affect measurement of transmittance, absorbance, and reflectance. Further, the above-mentioned influence of fluctuations in these energy values becomes particularly pronounced in wavelength ranges with low energy values.

For example, when a sample with an energy value of 80 is measured relative to a baseline with an energy value of 100, transmittance will be 80%, and when a sample with an energy value of 80 is measured relative to a baseline with an energy value of 99, transmittance will be 80.8%. On the other hand, when a sample with an energy value of 4 is measured relative to a baseline with an energy value of 5, transmittance will be 80%, and when a sample with an energy value of 4 is measured relative to a baseline with an energy value of 4, transmittance will be 100%. As described above, in wavelength ranges with high energy values, the influence of energy value fluctuations on transmittance, absorbance, and reflectance is small, but in wavelength ranges with low energy values, the influence becomes larger, which causes significant errors in the measurement results.

Accordingly, in the spectrophotometer 100 having this configuration, an averaging process of a baseline for each wavelength is performed by the controller 18 when the baseline is measured. Accordingly, it is possible to suppress occurrence of errors when measurement values in actual measurement are corrected using the baseline.

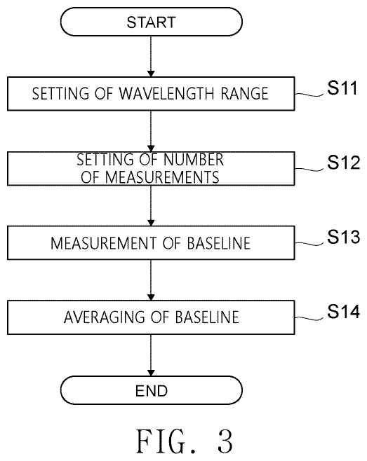

Next, the averaging process by the controller 18 in baseline measurement is described. The baseline measurement may be performed by a program stored in the storage of the controller 18 or may be manually performed. Further, the baseline measurement may be performed with actual measurement of a measurement sample and may be performed first before actual measurement, so the actual timing is not limited. FIG. 3 is a flowchart showing an averaging process in baseline measurement that is performed by the controller 18.

A user sets a measurement wavelength range by operating the instruction input portion 23 and inputting a start wavelength and an end wavelength for baseline measurement (S11). For the measurement wavelength range, the setting value for the measurement wavelength range in actual measurement may be used. Further, the user operates the instruction input portion 23 and inputs and sets the number of measurements N of the baseline measurement (S12). Further, when the baseline measurement is performed with actual measurement, the measurement wavelength range or the number of measurements N is set when the conditions of the actual measurement are set.

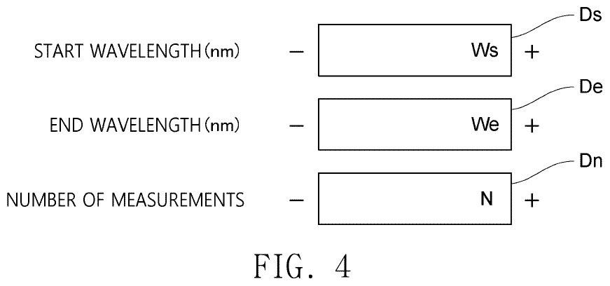

FIG. 4 shows an example of a part of an input image for settings on the display unit 22. The input image includes an input field Ds for a start wavelength Ws and an input field De for an end wavelength We in actual measurement and baseline measurement. Further, the input image includes an input field for the number of measurements N in baseline measurement. A user inputs a start wavelength Ws into the input field Ds, an end wavelength We into the input field De, and the number of measurements N into the input field Dn by operating the instruction input portion 23. FIG. 4 shows the input image with “Ws”, “We”, and “N”, but actual numerical values are displayed. Further, a user can simply increase or decrease the numerical values by pressing “+” and “−” buttons in the input image using an input device such as a mouse.

After inputting the start wavelength Ws and the end wavelength We in the measurement wavelength range of the baseline and the number of measurements N of the baseline, the user starts baseline measurement by operating the instruction input portion 23. Then, the controller 18 performs the baseline measurement in the input wavelength range, for example, by continuously measuring from a long-wavelength side to a short-wavelength side. The baseline is repeatedly measured by the set number of measurements N for the wavelength range from the set start wavelength Ws and end wavelength We (S13). In this case, the controller 18 sets a scanning speed when repeatedly measuring the baseline by the number of measurements N, that is, the wavelength changing speed for changing the wavelength of light to be extracted by rotating the diffraction gratin 31 to be the same as the wavelength changing speed (scanning speed) in actual measurement when a measurement sample is measured. Accordingly, the measurement conditions of the baseline are adjusted to match the measurement conditions of the actual measurement.

The controller 18 averages the baseline in the measured wavelength range for each wavelength using a method such as dividing the accumulated values of measurement data obtained by measuring the baseline in a specific wavelength range by the number of measurements N (S14).

As described above, according to the first embodiment, a baseline in a specified wavelength range is repeatedly measured and averaged, whereby it is possible to appropriately average a baseline that is influenced by fluctuations of the energy value of the light source 1 that changes depending on each wavelength range. Accordingly, the influence on the measurement accuracy depending on fluctuations of the energy value of the light from the light source is suppressed.

Further, since a baseline is repeatedly measured at the wavelength changing speed in actual measurement, the measurement conditions in measurement of a base line and actual measurement of a sample can be matched to each other. For example, in a method of suppressing the influence of temporal changes of a detected light quantity by setting the wavelength scanning speed of baseline measurement to a low speed, the conditions of the baseline measurement at the low speed are matched to the measurement conditions of the actual measurement a sample, so it is not required to set the wavelength changing speed of the actual measurement to a low speed. In this case, the measurement time of the actual measurement increases. Meanwhile, as in this method, when a baseline is repeatedly measured with a wavelength changing speed the same as the wavelength changing speed of actual measurement, the wavelength changing speed in the actual measurement can be maintained at a normal speed, so the measurement time of the actual measurement does not increase. Further, it is possible to maintain the reliability of a correction value using a baseline at a high level and a stable measurement result is obtained even in measurement for a wavelength range with a low energy value of light.

A double beam spectrophotometer that performs sample analysis by emitting sample-side luminous flux 4 and reference-side luminous flux 8 to a sample and a reference sample is exemplified as the spectrophotometer 100 in this embodiment, but the present disclosure is not limited thereto and the measurements described above can be performed even in a single beam type without reference-side luminous flux or a ratio-beam type without a reference sample stage.

Further, in the measurement procedure described above, baseline measurement is repeatedly performed for the entire measurement wavelength range in actual measurement, but it is also possible to selectively perform repeated measurements only, particularly for a specific wavelength range particularly with a low energy value. In this case, the instruction input portion 23 is provided with an input function for the start wavelength Ws and the end wavelength We of baseline measurement such as the input fields Ds and De shown in FIG. 4 and configured to allow setting a specific wavelength region of the start wavelength Ws and the end wavelength We for repeated baseline measurement. Only a baseline in the specific wavelength range set in this way is selectively and repeatedly measured by the specified number of measurements N.

In detail, a baseline is measured by continuously changing the wavelength of light that is extracted while changing the angle of the diffraction grating 31 by controlling the motor 32 shown in FIG. 1. In this case, measurement for a specific wavelength range is performed a plurality of times through a reciprocating operation while reversing the scanning direction in the specific measurement wavelength range. That is, an operation of gradually decreasing a wavelength from a start wavelength Ws to an end wavelength We, then returning the wavelength to the start wavelength Ws, and then gradually decreasing the wavelength from the start wavelength Ws to the end wavelength We is repeated in accordance with the number of measurements N. Alternatively, a reciprocating operation of gradually decreasing a wavelength from a start wavelength Ws to an end wavelength We and then gradually increasing the wavelength to the start wavelength Ws may be repeated in accordance with the number of measurements N.

In both cases, the controller 18 sets the scanning speed, that is, a wavelength changing speed when repeatedly measuring a baseline in a specific measurement wavelength range by the number of measurement N to be the same as the wavelength changing speed (scanning speed) in actual measurement when measuring a measurement sample. According to this method, it is possible to efficiently and accurately obtain a baseline in the entire wavelength range. Further, a more accurate and stable measurement result is obtained by correcting the spectral intensity distribution of a measured sample using an obtained baseline.

### Second Embodiment

Next, a second embodiment is described. In this embodiment, a wavelength range particularly with a low energy value is set as a specific wavelength range for the repeated baseline measurement based on the energy distribution of light from the light source 1.

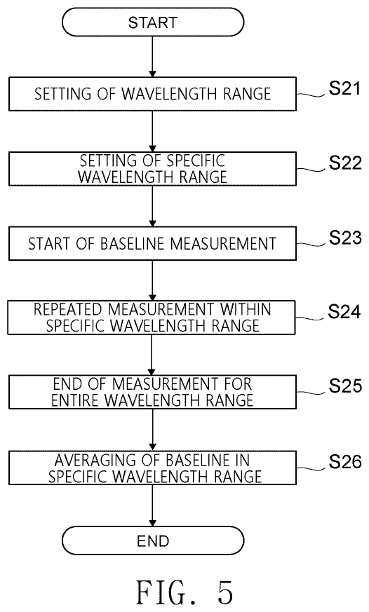

FIG. 5 is a flowchart illustrating an averaging process of a baseline in the second embodiment. A user sets a measurement wavelength range for baseline measurement by operating the instruction input portion 23 (s21). After inputting the measurement wavelength range for baseline measurement, the user instructs the start of the baseline measurement by operating the instruction input portion 23.

The controller 16 receives the instruction to start measurement, refers to the type information of the light source 1 stored in the storage, and sets a wavelength range with a low energy value of the light source 1 as a specific wavelength range based on the distribution of the energy value in the type information of the light source 1 (S22). The type information of the light source 1 includes the distribution information of the energy value of the light that is emitted by the light source. For example, a threshold value that is the lower end of an energy value is set in advance, a wavelength range in which the energy value of light is equal to or lower than the threshold value is extracted from the type information of the light source 1, and the wavelength range is set as a specific wavelength range. Then, the controller 18 starts baseline measurement in the measurement wavelength range (S23).

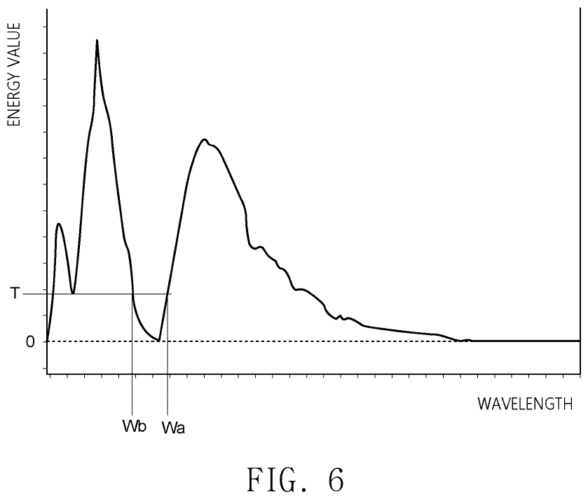

FIG. 6 is a graph showing an example of distribution of an energy value in the type information of a light source. As shown in FIG. 6, the light from the light source 1 has differences in energy value, depending on wavelength ranges, and for example, in a wavelength range Wa˜Wb in which the energy value is particularly low, the measurement values after correction greatly fluctuates depending on the size of a baseline. Accordingly, the controller 18, as described above, sets a wavelength range Wa˜Wb in which the energy value is lower than a preset threshold value T as a specific wavelength range in the entire wavelength range of the light source 1.

The controller 18 performs baseline measurement while changing a measurement wavelength, and when the measurement wavelength enters the specific wavelength range Wa˜Wb, the controller 18 repeats baseline measurement within the wavelength range Wa˜Wb by the number of measurements N set in accordance with the procedure described above (S24). The wavelength changing speed is set to be the same as the wavelength changing speed in actual measurement in this case as well.

Further, after repeated measurement in the specific wavelength range Wa˜Wb, measurement in the entire measurement wavelength range is ended (S25). Further, the controller 18 performs an averaging process of the baseline for each wavelength in the specific wavelength range Wa˜Wb (S26). In this averaging process, the controller 18 calculates the average value for each wavelength by dividing the accumulated values of measurement data repeatedly measured in the set specific wavelength range Wa˜Wb by the number of measurements N or using other methods. A baseline in the entire wavelength range is obtained from the average values in the specific wavelength range and the measurement values outside the specific wavelength range.

According to this embodiment, it is possible to efficiently average a baseline by setting a wavelength range with a low energy value as a specific wavelength range based on the type information of the light source 1 and selectively and repeatedly performing baseline measurement a plurality of times for the specific wavelength range. Accordingly, it is possible to suppress the influence on measurement accuracy due to fluctuations of energy values, and particularly, even though an energy value is low, it is possible to prevent deterioration of measurement accuracy in actual measurement.

Further, in this embodiment, the controller 18 can monitor, in real time, fluctuations of data of a measured baseline or measurement data of a sample, and when a fluctuation exceeds a preset threshold value, the controller 18 can also notify a user by displaying guidance such as prompting an averaging process of the baseline on the display unit 22. In this way, the user can perform an averaging process of a baseline as needed, based on a notification to prompt an averaging process from the controller 18. Further, instead of a notification or along with a notification, an averaging process of a baseline may be automatically performed for a wavelength range in which a fluctuation exceeds a threshold value.

In an averaging process by the controller 18, there are cases in which an outlier that is a clearly large fluctuation appears in the measurement values of a measured baseline. For example, when external light inadvertently enters the sample chamber 11 during measurement, outliers that are large fluctuations of measurement values occur. In this case, the controller 18 can perform an averaging process by excluding outliers. Further, when an outlier occurs, it is possible to notify a user, for example, by displaying an error on the display unit 22. Further, when an outlier occurs during an averaging process, it may be possible to perform a self-diagnosis process for identifying the cause of the outlier or issue a notification to prompt the execution of the process.

Further, as a baseline that is used for actual measurement of a sample, a measured baseline may be used instead of measuring a baseline for every actual measurement. For example, when it is difficult to regularly supply a baseline solution, it may be possible to use a baseline measured using a standard stored externally. The information of measured baselines may be supplied from other devices through a network line by connecting the controller 18 of the spectrophotometer 100 to the network line, and may be supplied through an appropriate storage medium.

Further, the baseline measurement described above may be suitably applied in inline measurement in which a sample flowing through a process pipe is directly measured, and in online measurement in which a representative sample is drawn from a process pipe into a bypass pipe for real-time measurement, for rapid measurement.

The present disclosure is not limited to the embodiments described above, and combinations of the configurations in the embodiments, as well as modifications and applications made by those skilled in the art based on the descriptions of this specification and well-known techniques, are also intended to be within the scope of the present disclosure.

As described above, the following aspects are disclosed in this specification.

(1) A spectrophotometer including:
a light source;
a spectrometer configured to separate light from the light source at a specified wavelength changing speed;
a detector configured to detect sample transmission luminous flux that is transmitted through a measurement sample, which is separated by the spectrometer and transmitted through the measurement sample, for each wavelength; and
a controller configured to obtain spectral intensity distribution of the luminous flux that is transmitted through the measurement sample based on a measurement sample signal of the luminous flux that is transmitted through the measurement sample outputted from the detector,
wherein the controller repeatedly performs measurement of a baseline, which represents background intensity of the measurement sample signal for each wavelength, a plurality of times at a wavelength changing speed at the time of measurement of the measurement sample and obtains an averaged baseline by averaging a plurality of measurement values of the baseline for each wavelength and
corrects the spectral intensity distribution using the averaged baseline.

According to the spectrophotometer, by averaging a baseline by repeatedly performing measurement of the baseline, it is possible to appropriately average a baseline that is affected by fluctuations of an energy value of a light source that changes depending on wavelength ranges. Accordingly, it is possible to suppress the influence on measurement accuracy due to fluctuations of the energy value of a light source. Further, since a baseline is repeatedly measured at the wavelength changing speed in actual measurement, the measurement conditions in measurement a baseline and actual measurement of spectral intensity distribution can be matched to each other. Therefore, even though a baseline is measured at a low wavelength changing speed, it is possible to efficiently perform spectral analysis without a decrease in wavelength changing speed for spectral intensity distribution.

(2) The spectrophotometer described in (1) further includes an instruction input portion where a number of measurements of the baseline can be inputted, and
the controller repeats measurement of the baseline by the number of measurements of the baseline that is inputted.

According to the spectrophotometer, a user can freely set the number of measurements of a baseline, so it is possible to easily implement required accuracy of a baseline and it is possible to stably measure spectral intensity distribution with high accuracy.

(3) The spectrophotometer described in (1) or (2), wherein the controller sets a wavelength range, in which an energy value of light from the light source is equal to or lower than a threshold value, as a specific wavelength range based on type information representing a type of the light source; and
obtains the averaged baseline by averaging a plurality of measurement values, that is obtained by repeating measurement of the baseline a plurality of times for each wavelength in the specific wavelength range.

According to the spectrophotometer, it is possible to efficiently average a baseline by setting, for example, a wavelength range with a low energy value as a specific wavelength range and repeatedly performing measurement a plurality of times for the specific wavelength range. Accordingly, it is possible to suppress the influence on measurement accuracy due to fluctuations of energy values.

(4) The spectrophotometer described in any one of (1) to (3), wherein the controller monitors a fluctuation of at least one of measurement values of the baseline and measurement values of the measurement sample; and, when an amplitude of the fluctuation exceeds a predetermined threshold value, the controller notifies to prompt averaging of the baseline in the wavelength range in which the fluctuation occurs.

According to the spectrophotometer, it is possible to perform an averaging process of a baseline as needed based on a notification to prompt averaging of a baseline from the controller.

(5) The spectrophotometer described in any one of (1) to (4) further includes a beam splitter configured to separate a light path of light separated by the spectrometer into sample-side luminous flux leading to the measurement sample and reference-side luminous flux leading to a reference sample,
wherein the detector comprises a sample-side detector configured to detect the sample-side luminous flux that has passed through the sample and a reference-side detector configured to detect the reference-side luminous flux that has passed through the reference sample, and
the controller obtains the spectral intensity distribution of the sample-side luminous flux based on a measurement sample signal of the sample-side luminous flux detected by the sample-side detector and a reference sample signal of the reference-side luminous flux detected by the reference-side detector.

According to the spectrophotometer, a light path of light separated by the spectrometer is separated into sample-side luminous flux and reference-side luminous flux by the beam splitter and is detected by the sample-side detector and the reference-side detector. Accordingly, it is possible to avoid the influence of unevenness in the energy value of the light source over measurement time and suppress temporal fluctuations of a baseline, so it is possible to further increase the measurement accuracy of spectral intensity distribution.

(6) A method of spectrophotometric measurement that separates light from a light source at a specified wavelength changing speed, detects luminous flux that is transmitted through a measurement sample, which is transmitted through the measurement sample, for each wavelength, and obtains spectral intensity distribution of the luminous flux that is transmitted through the measurement sample based on a measurement sample signal of the luminous flux that is transmitted through the measurement sample that is detected, wherein the method
repeats measurement of a baseline, which represents background intensity of the measurement sample signal for each wavelength, a plurality of times at a wavelength changing speed that is identical to the wavelength changing speed at the time of measurement of the spectral intensity distribution;
obtains an averaged baseline by averaging a plurality of measurement values of the baseline that is repeatedly measured for each wavelength, and
corrects the spectral intensity distribution using the averaged baseline.

According to the method of spectrophotometric measurement, by averaging a baseline by repeatedly performing measurement of the baseline, it is possible to appropriately average a baseline that is affected by fluctuations of an energy value of a light source that changes depending on wavelength ranges. Accordingly, it is possible to suppress the influence on measurement accuracy due to fluctuations of the energy value of a light source. Further, since a baseline is repeatedly measured at the wavelength changing speed in actual measurement, the measurement conditions in measurement a baseline and actual measurement of spectral intensity distribution can be matched to each other. Therefore, even though a baseline is measured at a low wavelength changing speed, it is possible to efficiently perform spectral analysis without a decrease in wavelength changing speed for spectral intensity distribution.

(7) A program for performing a procedure of spectrophotometric measurement that separates light from a light source at a specified wavelength changing speed, detects luminous flux that is transmitted through a measurement sample, which is transmitted through the measurement sample, for each wavelength, and obtains spectral intensity distribution of the luminous flux that is transmitted through the measurement sample based on a measurement sample signal of the luminous flux that is transmitted through the measurement sample that is detected,
wherein the program executes: in a computer,
a procedure of repeating measurement of a baseline, which represents background intensity of the measurement sample signal for each wavelength, a plurality of times at a wavelength changing speed that is identical to the wavelength changing speed at the time of measurement of the spectral intensity distribution;
a procedure of obtaining an averaged baseline by averaging a plurality of measurement values of the baseline that is repeatedly measured for each wavelength, and
a procedure of correcting the spectral intensity distribution using the averaged baseline.

According to the program, by averaging a baseline by repeatedly performing measurement of the baseline, it is possible to appropriately average a baseline that is affected by fluctuations of an energy value of a light source that changes depending on wavelength ranges. Accordingly, it is possible to suppress the influence on measurement accuracy due to fluctuations of the energy value of a light source. Further, since a baseline is repeatedly measured at the wavelength changing speed in actual measurement, the measurement conditions in measurement a baseline and actual measurement of spectral intensity distribution can be matched to each other. Therefore, even though a baseline is measured at a low wavelength changing speed, it is possible to efficiently perform spectral analysis without a decrease in wavelength changing speed for spectral intensity distribution.

What is claimed is:

1. A spectrophotometer comprising:
a light source;
a spectrometer configured to separate light from the light source at a specified wavelength changing speed;
a detector configured to detect luminous flux that is transmitted through a measurement sample, which is separated by the spectrometer and transmitted through the measurement sample, for each wavelength; and
a controller configured to obtain spectral intensity distribution of the luminous flux that is transmitted through the measurement sample based on a measurement sample signal of the luminous flux that is transmitted through the measurement sample outputted from the detector,
wherein the controller repeatedly performs measurement of a baseline, which represents background intensity of the measurement sample signal for each wavelength, a plurality of times at a wavelength changing speed at the time of measurement of the measurement sample and obtains an averaged baseline by averaging a plurality of measurement values of the baseline for each wavelength; and
corrects the spectral intensity distribution using the averaged baseline.

2. The spectrophotometer according to claim 1, further comprising an instruction input portion where a number of measurements of the baseline can be inputted,
wherein the controller repeats measurement of the baseline by the number of measurements of the baseline that is inputted.

3. The spectrophotometer according to claim 1, wherein the controller sets a wavelength range, in which an energy value of light from the light source is equal to or lower than a threshold value, as a specific wavelength range based on type information representing a type of the light source; and
obtains the averaged baseline by averaging a plurality of measurement values, that is obtained by repeating measurement of the baseline a plurality of times for each wavelength in the specific wavelength range.

4. The spectrophotometer according to claim 1, wherein the controller monitors a fluctuation of at least one of measurement values of the baseline and measurement values of the measurement sample; and, when an amplitude of the fluctuation exceeds a predetermined threshold value, the controller notifies to prompt averaging of the baseline in the wavelength range in which the fluctuation occurs.

5. The spectrophotometer according to claim 1, further comprising a beam splitter configured to separate a light path of light separated by the spectrometer into sample-side luminous flux leading to the measurement sample and reference-side luminous flux leading to a reference sample,
wherein the detector comprises a sample-side detector configured to detect the sample-side luminous flux that has passed through the sample and a reference-side detector configured to detect the reference-side luminous flux that has passed through the reference sample, and
the controller obtains the spectral intensity distribution of the sample-side luminous flux based on a measurement sample signal of the sample-side luminous flux detected by the sample-side detector and a reference sample signal of the reference-side luminous flux detected by the reference-side detector.

6. The spectrophotometer according to claim 2, further comprising a beam splitter configured to separate a light path of light separated by the spectrometer into sample-side luminous flux leading to the measurement sample and reference-side luminous flux leading to a reference sample,
wherein the detector comprises a sample-side detector configured to detect the sample-side luminous flux that has passed through the sample and a reference-side detector configured to detect the reference-side luminous flux that has passed through the reference sample, and
the controller obtains the spectral intensity distribution of the sample-side luminous flux based on a measurement sample signal of the sample-side luminous flux detected by the sample-side detector and a reference sample signal of the reference-side luminous flux detected by the reference-side detector.

7. The spectrophotometer according to claim 3, further comprising a beam splitter configured to separate a light path of light separated by the spectrometer into sample-side luminous flux leading to the measurement sample and reference-side luminous flux leading to a reference sample,
wherein the detector comprises a sample-side detector configured to detect the sample-side luminous flux that has passed through the sample and a reference-side detector configured to detect the reference-side luminous flux that has passed through the reference sample, and
the controller obtains the spectral intensity distribution of the sample-side luminous flux based on a measurement sample signal of the sample-side luminous flux detected by the sample-side detector and a reference sample signal of the reference-side luminous flux detected by the reference-side detector.

8. The spectrophotometer according to claim 4, further comprising a beam splitter configured to separate a light path of light separated by the spectrometer into sample-side luminous flux leading to the measurement sample and reference-side luminous flux leading to a reference sample,
wherein the detector comprises a sample-side detector configured to detect the sample-side luminous flux that has passed through the sample and a reference-side detector configured to detect the reference-side luminous flux that has passed through the reference sample, and
the controller obtains the spectral intensity distribution of the sample-side luminous flux based on a measurement sample signal of the sample-side luminous flux detected by the sample-side detector and a reference sample signal of the reference-side luminous flux detected by the reference-side detector.

9. A method of spectrophotometric measurement that separates light from a light source at a specified wavelength changing speed, detects luminous flux that is transmitted through a measurement sample, which is transmitted through the measurement sample, for each wavelength, and obtains spectral intensity distribution of the luminous flux that is transmitted through the measurement sample based on a measurement sample signal of the luminous flux that is transmitted through the measurement sample that is detected, wherein the method
repeats measurement of a baseline, which represents background intensity of the measurement sample signal for each wavelength, a plurality of times at a wavelength changing speed that is identical to the wavelength changing speed at the time of measurement of the spectral intensity distribution;
obtains an averaged baseline by averaging a plurality of measurement values of the baseline that is repeatedly measured for each wavelength, and
corrects the spectral intensity distribution using the averaged baseline.

10. A program for performing a procedure of spectrophotometric measurement that separates light from a light source at a specified wavelength changing speed, detects luminous flux that is transmitted through a measurement sample, which is transmitted through the measurement sample, for each wavelength, and obtains spectral intensity distribution of the luminous flux that is transmitted through the measurement sample based on a measurement sample signal of the luminous flux that is transmitted through a measurement sample that is detected flux,
wherein the program executes: in a computer,
a procedure of repeating measurement of a baseline, which represents background intensity of the measurement sample signal for each wavelength, a plurality of times at a wavelength changing speed that is identical to the wavelength changing speed at the time of measurement of the spectral intensity distribution;
a procedure of obtaining an averaged baseline by averaging a plurality of measurement values of the baseline that is repeatedly measured for each wavelength, and
a procedure of correcting the spectral intensity distribution using the averaged baseline.
